(19) United States
(12) Patent Application Publication
(10) Pub. No.: US 2026/0260657 A1
(43) Pub. Date: Sep. 3, 2026

(54) METHOD FOR VOICEPRINT RECOGNITION, ELECTRONIC DEVICE, AND COMPUTER-READABLE STORAGE MEDIUM

(71) Applicant: MASHANG CONSUMER FINANCE CO., LTD., Chongqing (CN)

(72) Inventor: Yanli CHEN, Chongging (CN)

(21) Appl. No.: 19/330,699

(22) Filed: Sep. 16, 2025

(30) Foreign Application Priority Data
Feb. 28, 2025 (CN) 202510245947.7

(51) Int. Cl. G10L 17/02; G10L 17/06

(52) U.S. Cl. CPC G10L 17/02; G10L 17/06

(57) ABSTRACT

A method for voiceprint recognition, an electronic device, and a computer-readable storage medium. In response to a voiceprint recognition request, a first voiceprint feature of a first audio and respective second voiceprint features of a plurality of second audios are determined. A plurality of similarities between the first voiceprint feature and the respective second voiceprint features are determined, and a graph is constructed based on the plurality of similarities, the first voiceprint feature and the respective second voiceprint features. Mapping is performed on the first voiceprint feature and the respective second voiceprint features in the graph, to obtain a plurality of third voiceprint features and a confidence level. A voiceprint recognition result for the first audio is determined based on the plurality of third voiceprint features, the confidence level, or both the plurality of third voiceprint features and the confidence level.

### CROSS-REFERENCE TO RELATED APPLICATION

This application is based on and claims priority to Chinese patent application No. 202510245947.7, filed on Feb. 28, 2025 and entitled “METHOD AND APPARATUS FOR VOICEPRINT RECOGNITION, ELECTRONIC DEVICE, COMPUTER-READABLE STORAGE MEDIUM, AND COMPUTER PROGRAM PRODUCT”, the disclosure of which is hereby incorporated by reference in its entirety.

### TECHNICAL FIELD

The disclosure relates to speech recognition technology, and in particular to a method and apparatus for voiceprint recognition, an electronic device, a computer-readable storage medium, and a computer program product.

### BACKGROUND

With the development of Internet technology, more and more users tend to conduct services through online calls. In order to provide personalized services to users, during a call with a user, an identity of the user in the call is determined firstly. In the prior art, an usual approach of determining the identity of the user in the call is directly comparing, during the call, a feature of speech data of the user in the current call with features of historical speech data stored in a database, thereby obtaining the identity of the user. Although the identity of the user in the call can be obtained with this approach, there may be multiple features very similar to the feature of the user in the current call during the comparison process, which cannot ensure the accuracy of the obtained identity of the user.

### SUMMARY

Embodiments of the disclosure provide a method for voiceprint recognition, a non-transitory computer-readable storage medium.

The technical solutions in the embodiments of the disclosure are implemented as follows.

An embodiment of the disclosure provides a method for voiceprint recognition, including the following operations.

In response to a voiceprint recognition request, a first voiceprint feature of a first audio and respective second voiceprint features of a plurality of second audios are determined.

A plurality of similarities between the first voiceprint feature and the respective second voiceprint features are determined, and a graph is constructed based on the plurality of similarities, the first voiceprint feature and the respective second voiceprint features.

Mapping is performed on the first voiceprint feature and the respective second voiceprint features in the graph, to obtain a plurality of third voiceprint features and a confidence level.

A voiceprint recognition result for the first audio is determined based on the plurality of third voiceprint features, the confidence level, or both the plurality of third voiceprint features and the confidence level.

An embodiment of the disclosure provides an electronic device, including a memory and a processor.

The memory is configured to store a computer executable instruction or a computer program.

The processor is configured to implement, when executing the computer executable instruction or the computer program stored in the memory, the method for voiceprint recognition according to the embodiment of the disclosure or the method for training the model according to the embodiment of the disclosure.

An embodiment of the disclosure provides a non-transitory computer-readable storage medium, having stored thereon a computer program or a computer executable instruction that, when executed by a processor, implements the method for voiceprint recognition according to the embodiment of the disclosure or the method for training the model according to the embodiment of the disclosure.

### BRIEF DESCRIPTION OF THE DRAWINGS

FIG. 1 is a schematic diagram of an architecture of a system 100 for voiceprint recognition according to an embodiment of the disclosure;

FIG. 2A is a first schematic structural diagram of an electronic device 500 according to an embodiment of the disclosure;

FIG. 2B is a second schematic structural diagram of an electronic device 500 according to an embodiment of the disclosure;

FIG. 3A is a first schematic flowchart of a method for voiceprint recognition according to an embodiment of the disclosure;

FIG. 3B is a second schematic flowchart of a method for voiceprint recognition according to an embodiment of the disclosure;

FIG. 3C is a third schematic flowchart of a method for voiceprint recognition according to an embodiment of the disclosure;

FIG. 3D is a fourth schematic flowchart of a method for voiceprint recognition according to an embodiment of the disclosure;

FIG. 3E is a schematic flowchart of a method for training a model according to an embodiment of the disclosure;

FIG. 4 is a schematic diagram of a feature correlation graph according to an embodiment of the disclosure;

FIG. 5 is a schematic diagram of a voiceprint recognition model according to an embodiment of the disclosure; and

FIG. 6 is a schematic flowchart of an application of a method for voiceprint recognition according to an embodiment of the disclosure.

It should be noted that the above terms “first” and “second” are only used to distinguish different solutions, and do not indicate the degree of superiority or inferiority of the solutions or the priority in the implementation.

### DETAILED DESCRIPTION

In order to make the purpose, technical solutions, and advantages of the disclosure clearer, a detailed description of the disclosure is further provided below in conjunction with the drawings. The described embodiments should not be regarded as limitations on the disclosure. All other embodiments obtained by those of ordinary skill in the art without making inventive efforts shall fall within the scope of protection of the disclosure.

In the following description, references to “some embodiments” describe a subset of all possible embodiments. However, it may be understood that “some embodiments” may be the same subset or different subsets of all possible embodiments, and may be combined with each other without conflict.

In the following description, the terms “first/second/third” are only used to distinguish similar objects and do not indicate a specific order for the objects. It may be understood that “first/second/third” may be interchanged in the specific order or sequence where allowed, so that the embodiments of the disclosure described herein can be implemented in an order other than that illustrated or described herein.

In the embodiments of the disclosure, the term “module” or “unit” refers to a computer program or a part thereof with predetermined functions, which works in conjunction with other related parts to achieve a predetermined objective, and may be implemented entirely or partially through the use of software, hardware (e.g., a processing circuit or memory), or a combination thereof. Similarly, a processor (or multiple processors or memories) may be used to implement one or more modules or units. Furthermore, each module or unit may be a part of an integrated module or unit that includes the functionality of that module or unit.

Unless otherwise defined, all technical and scientific terms used in the embodiments of the disclosure have the same meanings as those commonly understood by those skilled in the art. The terms used in the embodiments of the disclosure are only for the purpose of describing the embodiments of the disclosure, and are not intended to limit the disclosure.

In practical applications of related data collection and processing in the embodiments of the disclosure, strict compliance with requirements of related laws and regulations is required, informed consent or separate consent from personal information subjects should be obtained, and subsequent data usage and processing should be conducted within the scope authorized by laws and regulations and by the personal information subjects.

Before providing further detailed descriptions of the embodiments of the disclosure, the nouns and terms involved in the embodiments of the disclosure are explained. The nouns and terms involved in the embodiments of the disclosure shall be interpreted as follows.

1) In response to: this term is used to indicate condition(s) or state(s) on which executed operation(s) relies. When the relied condition(s) or state(s) are met, one or more operations may be executed in real time or with a set delay. Unless otherwise specified, there is no limitation on the order of execution for multiple operations executed.

Voice, as one of biological features, is typically processed by a feature extractor that encodes audios to extract corresponding audio features. Then, a similarity-based method is used for evaluation, such as cosine distance, Euclidean distance, or other distance metrics suitable for the data type. Specifically, if a similarity between features of two voices is greater than a certain threshold, the two voices belong to the same person; otherwise, the two voices belong to different persons. This evaluation method does not show obvious drawbacks when applied in small-scale quantity. However, when dealing with a large-scale voiceprint database, setting a threshold too high may result in a large number of missed detections, while setting the threshold too low may result in a large number of false alarms.

The embodiments of the disclosure provide a method and apparatus for voiceprint recognition, a device, a computer-readable storage medium, and a computer program product, which can improve the accuracy of voiceprint recognition. The following describes an exemplary application of a device for voiceprint recognition according to an embodiment of the disclosure. The device provided in the embodiment of the disclosure may be implemented as various types of terminals such as a laptop computer, a tablet computer, a desktop computer, a set-top box, a smartphone, a smart speaker, a smart watch, a smart television, an in-vehicle terminal, etc., and may also be implemented as a server. Below, an exemplary application is described in a case where the device is implemented as a server.

Embodiments of the disclosure provide a method and apparatus for voiceprint recognition, a computer-readable storage medium, and a computer program product, which can improve the accuracy of voiceprint recognition.

The technical solutions in the embodiments of the disclosure are implemented as follows.

An embodiment of the disclosure provides a method for voiceprint recognition, including the following operations.

In response to a voiceprint recognition request, a first voiceprint feature of a first audio and second voiceprint features of multiple second audios are determined.

A plurality of first similarities between the first voiceprint feature and the respective second voiceprint features are determined, a feature correlation graph is constructed based on the plurality of first similarities.

Feature mapping is performed on respective voiceprint features of nodes in the feature correlation graph, to obtain respective third voiceprint features and a confidence level of the nodes.

A voiceprint recognition result for the first audio is determined based on at least one of the respective third voiceprint features or the confidence level of the nodes.

An embodiment of the disclosure provides an apparatus for voiceprint recognition, including a determining module, a constructing module, and a mapping module.

The determining module is configured to determine a first voiceprint feature of a first audio and respective second voiceprint features of multiple second audios in response to a voiceprint recognition request.

The constructing module is configured to determine a plurality of first similarities between the first voiceprint feature and the respective second voiceprint features, and construct a feature correlation graph based on the plurality of first similarities.

The mapping module is configured to perform feature mapping on respective voiceprint features of nodes in the feature correlation graph, to obtain respective third voiceprint features and a confidence level of the nodes.

The determining module is further configured to determine a voiceprint recognition result for the first audio based on the respective third voiceprint feature of the nodes, the confidence level of the nodes, or both respective third voiceprint features and the confidence level of the nodes.

In some embodiments, the constructing module is further configured to determine, based on the plurality of first similarities, respective correlations of the first voiceprint feature with the second voiceprint features, the correlations comprising “correlated” and “uncorrelated”; and take the first voiceprint feature and the second voiceprint features as nodes, connect nodes of which correlations are “correlated”, to obtain the feature correlation graph.

In some embodiments, the constructing module is further configured to: for each of the first similarities, in a case that the first similarity exceeds a first similarity threshold, determine that a correlation of the first voiceprint feature with a corresponding one of the second voiceprint features is “correlated”; and in a case that the first similarity does not exceed the first similarity threshold, determine that the correlation of the first voiceprint feature with the corresponding second voiceprint feature is “uncorrelated”.

In some embodiments, the constructing module is further configured to select, from the plurality of first similarities, a first number of second similarities and a second number of third similarities, herein the second similarities exceed a second similarity threshold, and the third similarities do not exceed the second similarity threshold; and determine that correlations of the first voiceprint feature with respective second voiceprint features corresponding to the first number of second similarities are “correlated”, and determine that correlations of the first voiceprint feature with respective second voiceprint features corresponding to the second number of third similarities are “uncorrelated”.

In some embodiments, the mapping module is further configured to perform graph convolution processing on the respective voiceprint features of the nodes in the feature correlation graph, to obtain respective graph convolution features of the nodes; perform feature mapping on the respective graph convolution features of the nodes, to obtain the respective third voiceprint features of the nodes; perform nonlinear mapping on the respective third voiceprint features of the nodes, to obtain respective mapping features of the nodes; and perform confidence prediction on the respective mapping features of the nodes, to obtain the confidence level of the nodes.

In some embodiments, the mapping module is further configured to determine a feature correlation matrix corresponding to the feature correlation graph and a node feature matrix corresponding to the respective voiceprint features of the nodes; and perform graph convolution processing on the feature correlation matrix and the node feature matrix, to obtain the respective graph convolution features of the nodes.

In some embodiments, the determining module is further configured to: in a case that a number of one or more third audios belonging to a second user among the multiple second audios exceeds a third number, select, from the respective third voiceprint features of the nodes, a fourth voiceprint feature of a first node corresponding to the first audio and one or more fifth voiceprint features of one or more second nodes corresponding to the one or more third audios; calculate a fourth similarity between the fourth voiceprint feature and the one or more fifth voiceprint features; and in a case that the fourth similarity exceeds a third similarity threshold, obtain a voiceprint recognition result that the first audio belongs to the second user.

In some embodiments, the determining module is further configured to: in a case that the confidence level is greater than a first confidence threshold and less than a second confidence threshold, determine, in the feature correlation graph, one or more fourth nodes that are correlated with a third node corresponding to the first audio; determine one or more fourth audios corresponding to the one or more fourth nodes among the multiple second audios, and determine one or more third users to which the one or more fourth audios belong; and determine, based on the one or more third users to which the one or more fourth audios belong, the voiceprint recognition result for the first audio.

In some embodiments, the determining module is further configured to: in a case that a number of the one or more fourth nodes is one, obtain a voiceprint recognition result that the first audio belongs to the third user; in a case that the number of the one or more fourth nodes is multiple, determine, for each of the third users, a respective number of the fourth audios associated with the first user; and take one of the third users, to which a largest number of the fourth audios belongs, as a fourth user, and obtain a voiceprint recognition result that the first audio belongs to the fourth user.

In some embodiments, the determining module is further configured to: in a case that the confidence level does not exceed the first confidence threshold or exceeds the second confidence threshold, determine one or more fifth similarities between a third voiceprint feature of the node corresponding to the first audio and respective third voiceprint features of the nodes corresponding to the second audios; determine, based on the fifth similarities, a fifth audio with a highest one of the fifth similarities among the multiple second audios; and determine a fourth user to which the fifth audio belongs, and obtain a voiceprint recognition result that the first audio belongs to the fourth user.

In some embodiments, the determining module is further configured to parse the voiceprint recognition request to obtain the first audio carried by the voiceprint recognition request, and obtain the multiple second audios of a first user who triggered the voiceprint recognition request within a first time period; and perform voiceprint feature extraction on the first audio and each of the second audios, to obtain the first voiceprint feature of the first audio and a second voiceprint feature of the respective one of the second audios.

An embodiment of the disclosure provides an apparatus for training a model, implementing the following operations.

Through a voiceprint recognition model, a sixth voiceprint feature of a first audio sample and respective seventh voiceprint features of multiple second audio samples are determined.

A plurality of sixth similarities between the sixth voiceprint feature and the respective seventh voiceprint features are determined, and a feature correlation graph is constructed based on the plurality of sixth similarities.

Feature mapping is performed on respective voiceprint features of nodes in the feature correlation graph, to obtain a first confidence level of the nodes.

A loss function is constructed based on the first confidence level of the nodes and second confidence levels annotated for respective audio samples corresponding to the nodes, and one or more parameters of the voiceprint recognition model are updated based on the loss function.

An embodiment of the disclosure provides an electronic device, including a memory and a processor.

The memory is configured to store a computer executable instruction or a computer program.

The processor is configured to implement, when executing the computer executable instruction or the computer program stored in the memory, the method for voiceprint recognition according to the embodiment of the disclosure or the method for training the model according to the embodiment of the disclosure.

An embodiment of the disclosure provides a computer-readable storage medium, having stored thereon a computer program or a computer executable instruction that, when executed by a processor, implements the method for voiceprint recognition according to the embodiment of the disclosure or the method for training the model according to the embodiment of the disclosure.

An embodiment of the disclosure provides a computer program product, including a computer program or a computer executable instruction that, when executed by a processor, implements the method for voiceprint recognition according to the embodiment of the disclosure or the method for training the model according to the embodiment of the disclosure.

The embodiments of the disclosure have the following beneficial effects.

In response to a voiceprint recognition request, a first voiceprint feature of a first audio and second voiceprint features of multiple second audios are determined. A plurality of first similarities between the first voiceprint feature and the respective second voiceprint features are determined, a feature correlation graph is constructed based on the plurality of first similarities. By constructing the feature correlation graph between the first voiceprint feature and the respective second voiceprint features, second voiceprint features similar to the first voiceprint feature are obtained. Subsequently, only the second voiceprint features included in the feature correlation graph need to be processed, instead of processing all the second voiceprint features, thereby saving computational resources and improving the efficiency of subsequent voiceprint recognition. Feature mapping is performed on respective voiceprint features of nodes in the feature correlation graph, to obtain respective third voiceprint features and a confidence level of the nodes. A voiceprint recognition result for the first audio is determined based on the respective third voiceprint feature of the nodes, the confidence level of the nodes, or both respective third voiceprint features and the confidence level of the nodes. By performing feature mapping on the nodes included in the feature correlation graph, information about the correlation relationship between the nodes in the feature correlation graph is included in the feature mapping process, which improves the accuracy of the obtained third voiceprint features and confidence level, thereby improving the accuracy of subsequent voiceprint recognition result obtained based on the third voiceprint features and/or the confidence level.

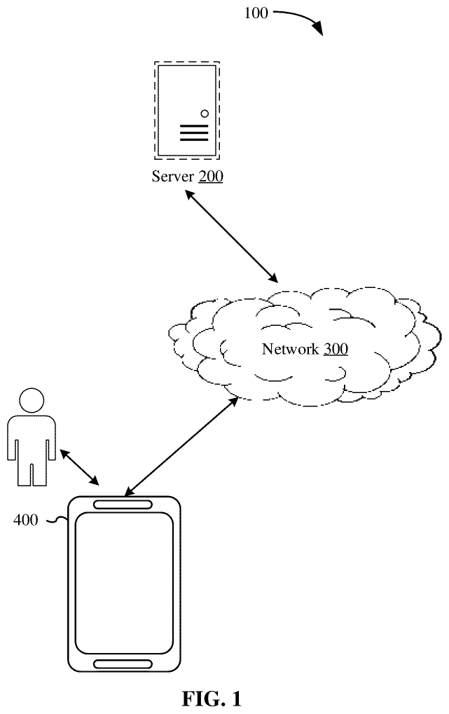

Referring to FIG. 1, FIG. 1 is a schematic diagram of an architecture of a system 100 for voiceprint recognition according to an embodiment of the disclosure. To support a voiceprint application, a terminal 400 is connected to a server 200 through a network 300, which may be a wide area network, a local area network, or a combination thereof.

The terminal 400 is configured to obtain a first audio input by a user through an audio capture device arranged in the terminal 400, and to transmit a voiceprint recognition request to the server 200 through an application client included in the terminal 400 over the network 300.

The server 200 is configured to: determine a first voiceprint feature of a first audio and second voiceprint features of multiple second audios in response to a voiceprint recognition request; determine a plurality of first similarities between the first voiceprint feature and the respective second voiceprint features, and construct a feature correlation graph based on the plurality of first similarities; perform feature mapping on respective voiceprint features of nodes in the feature correlation graph, to obtain respective third voiceprint features and a confidence level of the nodes; and determine a voiceprint recognition result for the first audio based on the respective third voiceprint features and/or the confidence level of the nodes, and return the voiceprint recognition result to the terminal 400.

In some embodiments, the server 200 may be a standalone physical server, a server cluster or distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks (CDNs), and platforms for big data and artificial intelligence. The terminal and the server may be directly or indirectly connected through wired or wireless communication means, and no limits are made thereto in the embodiments of the disclosure.

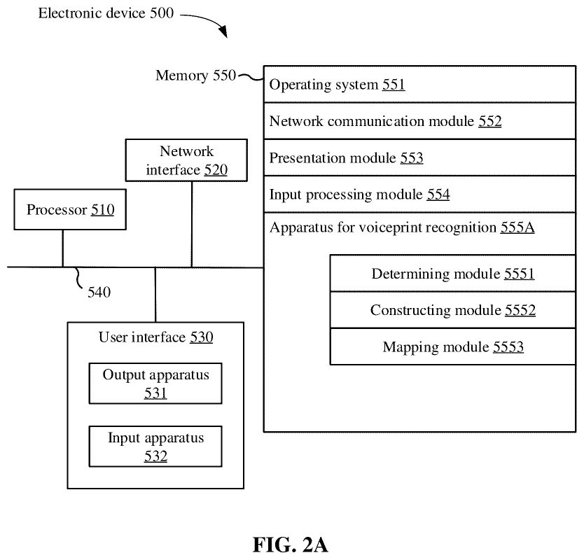

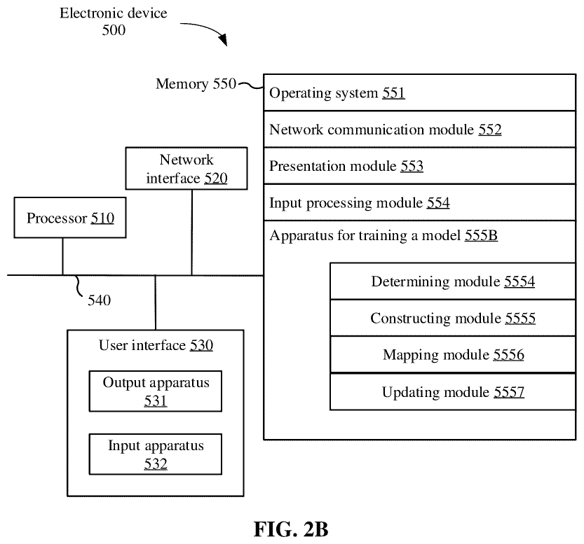

Referring to FIG. 2A to FIG. 2B, FIG. 2A and FIG. 2B are schematic structural diagrams of an electronic device 500 according to embodiments of the disclosure. Taking the electronic device 500 as the server 200 in FIG. 1 as an example, the electronic device 500 shown in FIG. 2A and FIG. 2B includes: at least one processor 510, a memory 550, at least one network interface 520, and a user interface 530. The various components in the electronic device 500 are coupled together through a bus system 540. It may be understood that the bus system 540 is configured to achieve connection and communication between these components. The bus system 540 includes not only a data bus, but also a power bus, a control bus, and a status signal bus. However, for the sake of clarity, various buses are labeled as the bus system 540 in FIG. 2A and FIG. 2B.

The processor 510 may be an integrated circuit chip with signal processing capabilities, such as a general-purpose processor, a digital signal processor (DSP), or other programmable logic devices, discrete gates or transistor logic devices, discrete hardware components, etc. The general-purpose processor may be a microprocessor or any conventional processor, etc.

The user interface 530 includes one or more output apparatuses 531 that enable the presentation of media content, including one or more speakers and/or one or more visual display screens. The user interface 530 further includes one or more input apparatuses 532, including user interface components that facilitate user input, such as a keyboard, a mouse, a microphone, a touchscreen display, a camera, other input buttons, and controls.

The memory 550 may be removable, non-removable, or a combination thereof. Exemplary hardware devices include solid-state memory, hard disk drives, optical disk drives, etc. The memory 550 optionally includes one or more storage devices that are physically located away from the processor 510.

The memory 550 includes volatile memory or non-volatile memory, and may also include both volatile memory and non-volatile memory. The non-volatile memory may be a read-only memory (ROM), and the volatile memory may be a random access memory (RAM). The memory 550 described in the embodiments of the disclosure is intended to include any suitable type of memory.

In some embodiments, the memory 550 is capable of storing data to support various operations. Examples of such data include programs, modules, and data structures, or subsets or supersets thereof. The following provides exemplary descriptions.

An operating system 551 includes system programs for processing various basic system services and executing hardware-related tasks. For example, the operating system 551 includes a framework layer, a core library layer, a driver layer, etc., configured to implement various basic services and process hardware based tasks.

A network communication module 552 is configured to communicate with other electronic devices via one or more (wired or wireless) network interfaces 520. Exemplary network interfaces 520 include Bluetooth, Wireless Fidelity (Wi-Fi), and Universal Serial Bus (USB), etc.

A presentation module 553 is configured to enable the presentation of information via one or more output apparatuses 531 (e.g., display screens, speakers, etc.) associated with the user interface 530 (e.g., a user interface configured to operate peripheral devices and display content and information).

An input processing module 554 is configured to detect one or more user inputs or interactions from one or more input apparatuses 532 and translate the detected one or more inputs or interactions.

In some embodiments, an apparatus provided in the embodiments of the disclosure may be implemented in software. FIG. 2A illustrates an apparatus 555A for voiceprint recognition stored in the memory 550. The apparatus 555A for voiceprint recognition may be software in the form of programs and plugins, etc., and includes the following software modules: a determining module 5551, a constructing module 5552, and a mapping module 5553. These modules are logical, and may be arbitrarily combined or further divided according to the implemented functions. The functions of each of the modules will be described below.

In some embodiments, an apparatus for training a model provided in the embodiments of the disclosure may be implemented in software. FIG. 2B illustrates an apparatus 555B for training a model stored in the memory 550. The apparatus 555B for training the model may be software in the form of programs and plugins, etc., and includes the following software modules: a determining module 5554, a constructing module 5555, a mapping module 5556, and an updating module 5557. These modules are logical, and may be arbitrarily combined or further divided according to the implemented functions. The functions of each of the modules will be described below.

In other embodiments, an apparatus provided in the embodiments of the disclosure may be implemented in hardware. As an example, the apparatus provided in the embodiments of the disclosure may be a processor in the form of a hardware decoding processor, which is programmed to perform a method for voiceprint recognition provided in the embodiments of the disclosure. For example, the processor in the form of the hardware decoding processor may be implemented using one or more Application Specific Integrated Circuits (ASICs), Digital Signal Processors (DSPs), Programmable Logic Devices (PLDs), Complex Programmable Logic Devices (CPLDs), Field-Programmable Gate Arrays (FPGAs), or other electronic components.

Below, a method for voiceprint recognition according to an embodiment of the disclosure is described. As mentioned above, the electronic device that implements the method for voiceprint recognition in the embodiments of the disclosure may be a terminal, a server, or a combination thereof. Therefore, the executing entity of each operation will not be repeated in the following description.

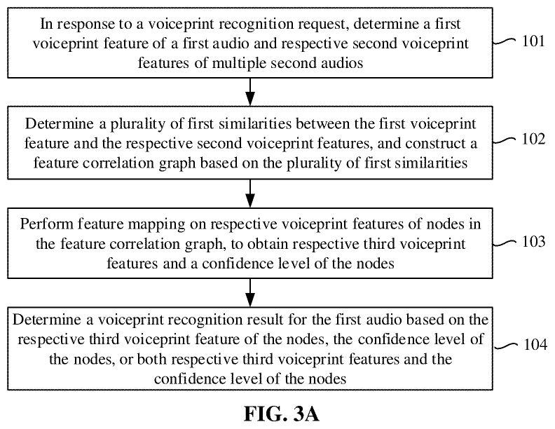

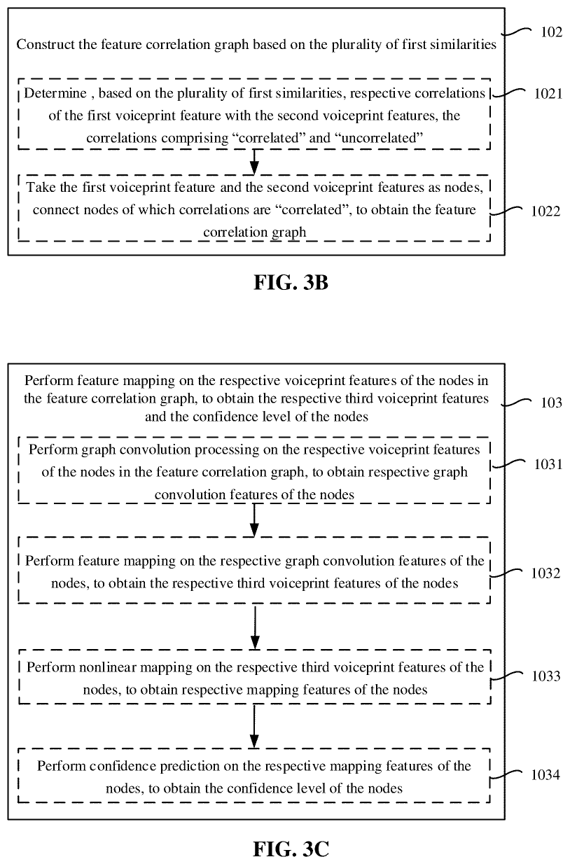

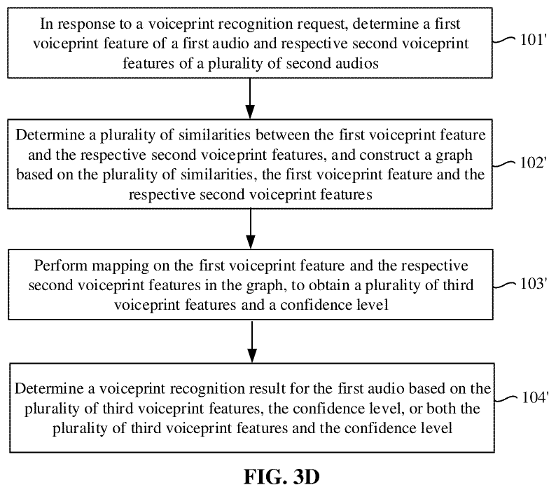

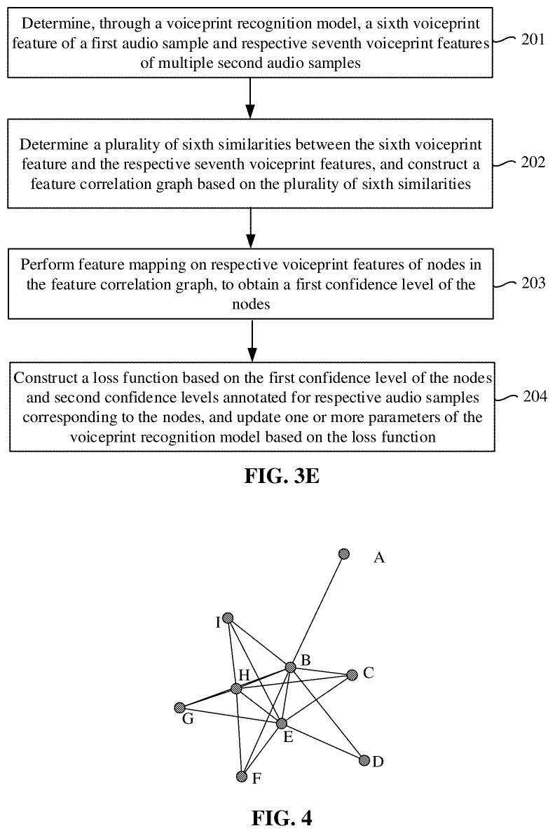

Referring to FIG. 3A, FIG. 3A is a first schematic flowchart of a method for voiceprint recognition according to an embodiment of the disclosure. The description will be given in conjunction with operations shown in FIG. 3A.

At operation 101, in response to a voiceprint recognition request, a first voiceprint feature of a first audio and respective second voiceprint features of multiple second audios are determined.

In practical implementation, the voiceprint recognition request may be a request transmitted from a client to a server. After a user establishes communication with the client, the client adds an audio of the user in a current call to the voiceprint recognition request in order to identify an identity of the user, and transmits the voiceprint recognition request to the server. In response to the voiceprint recognition request, the server identifies the user's audio carried in the voiceprint recognition request.

As an example, the first audio may be an audio of the user in this call or a historical audio stored in a database. The second audios may be historical audios stored in the database, and the second audios are audios used for identifying voiceprint information of the first audio. Voiceprint information of the second audios may be pre-processed and stored in the database, so that the voiceprint information of the second audios may be directly obtained when determining the second audios.

In some embodiments, the operation that the first voiceprint feature of the first audio and the respective second voiceprint features of the multiple second audios are determined in operation 101 may be achieved through the following technical solution. The voiceprint request is parsed to obtain the first audio carried by the voiceprint request, and the multiple second audios of a first user who triggered the voiceprint request within a first time period are obtained. Voiceprint feature extraction is performed on the first audio and the second audios, to obtain the first voiceprint feature of the first audio and respective second voiceprint features of the second audios.

In practical applications, in response to the voiceprint recognition request, the voiceprint recognition request may be parsed, to obtain the first audio carried in the voiceprint recognition request and information representing a source of the first audio. For example, if the first audio is generated by account A 191XXXXXXXX during a call, the source information of the first audio is account A (i.e., the first user). Afterwards, the database may be retrieved to retrieve historical audios of account A within the first time period (i.e., a historical period, which may be set according to actual needs, such as taking a past month as the first time period, or taking a past week as the first time period, etc.), and the retrieved historical audios of account A are taken as the second audios. It should be noted that, voice of a user may change over time, and voice stored too long ago may differ greatly from current voice of the user. Therefore, historical audios within a preset time period (i.e., the first time period) from the current time may be defined as the second audios. For example, historical audios of the account within 3 years from the current time may be determined as the second audios.

In practical implementation, a process of extracting voiceprint features from the first audio and the second audios may be proceed as follows. First, an audio is framed and segmented into short-term frames. A window function (e.g., Hamming window or Hanning window) may be applied to smooth the beginning and end of the signal, preventing edge effects. Afterwards, the window function is applied to each of the frames, to reduce interference between adjacent frames. A Fast Fourier Transform (FTT) is applied to each of the frames, to transform the audio signal from time domain to frequency domain and obtain a frequency spectrum. The spectrum is passed through a Mel-frequency filter bank to transform the frequency to a Mel-frequency scale, which mimics human auditory perception. The energy in each frequency band is logarithmically processed to enhance discriminability. A discrete cosine transform (DCT) is applied to obtain a cepstrum, which helps to remove redundant information and preserve important frequency information. First few logarithmic Mel-frequency cepstral coefficients are extracted as the voiceprint feature.

At operation 102, a plurality of first similarities between the first voiceprint feature and the respective second voiceprint features are determined, a feature correlation graph is constructed based on the plurality of first similarities.

In some embodiments, the operation that the feature correlation graph is constructed based on the plurality of first similarities in operation 102 may be achieved through operations 1021 to 1022 shown in FIG. 3B.

At operation 1021, respective correlations of the first voiceprint feature with the second voiceprint features are determined based on the plurality of first similarities. The correlations include “correlated” and “uncorrelated”.

In some embodiments, the operation that respective correlations of the first voiceprint feature with the second voiceprint features are determined based on the plurality of first similarities in operation 1021 may be achieved through the following technical solution. For each of the first similarities, in a case that the first similarity exceeds a first similarity threshold, it is determined that a correlation of the first voiceprint feature with a corresponding one of the second voiceprint features is “correlated”; in a case that the first similarity does not exceed the first similarity threshold, it is determined that the correlation of the first voiceprint feature with the corresponding second voiceprint feature is “uncorrelated”.

In practical implementation, after obtaining the first voiceprint feature and the second voiceprint features, for each of the second voiceprint features, a first similarity between the first voiceprint feature and the second voiceprint feature may be determined. A way to determine the first similarity between the first voiceprint feature and the second voiceprint feature may be to take a cosine similarity between the first voiceprint feature and the second voiceprint feature as the first similarity between the first voiceprint feature and the second voiceprint feature, or to take a Euclidean distance between the first voiceprint feature and the second voiceprint feature as the first similarity between the first voiceprint feature and the second voiceprint feature.

In practical implementation, to determine whether the first voiceprint feature and the second voiceprint feature are correlated, the first similarity may be compared with the first similarity threshold. When the first similarity exceeds the first similarity threshold, it indicates that the first voiceprint feature and the second voiceprint feature are very similar. In this case, it may be determined that the first voiceprint feature and the second voiceprint feature are correlated. If the first similarity does not exceed the first similarity threshold, it indicates that the first voiceprint feature and the second voiceprint feature are dissimilar. In this case, it may be determined that the first voiceprint feature and the second voiceprint feature are uncorrelated.

In some embodiments, the operation that respective correlations of the first voiceprint feature with the second voiceprint features are determined based on the plurality of first similarities in operation 1021 may be achieved through the following technical solution. A first number of second similarities and a second number of third similarities are selected from the plurality of first similarities. The second similarities exceed a second similarity threshold, and the third similarities do not exceed the second similarity threshold. It is determined that correlations of the first voiceprint feature with respective second voiceprint features corresponding to the first number of second similarities are “correlated”, and it is determined that correlations of the first voiceprint feature with respective second voiceprint features corresponding to the second number of third similarities are “uncorrelated”.

In practical implementation, if there are too many second audios stored in the database of which similarity to the first audio exceeds the first similarity threshold, it may result in a large amount of data in the constructed feature correlation graph. For example, if there are 50000 second audios in the database of which similarity to the first audio exceeds the first similarity threshold, a number of nodes in the feature correlation graph will be 50000. In this case, the feature correlation graph will be particularly large and include a lot of useless information. Therefore, an upper limit for the number of the nodes in the feature correlation graph may be set. For example, it may be set that the feature correlation graph includes a maximum of 20 nodes. In this case, the first number is 20. The second voiceprint features may be sorted in descending order of similarity to the first voiceprint feature, to obtain a sequence of the second voiceprint features. A value between a first similarity between a 20th voiceprint feature in this sequence and the first voiceprint feature and a first similarity between a 21st voiceprint feature in this sequence and the first voiceprint feature, is selected as the second similarity threshold. For example, the first number is 20, the first similarity between the 20th voiceprint feature and the first voiceprint feature is 0.7, the first similarity between the 21st voiceprint feature and the first voiceprint feature is 0.65, and then the second similarity threshold may be set to 0.68. It should be noted that a sum of the first number and the second number may be a number of second audio features of which first similarity to the first audio feature exceeds the first similarity threshold. For example, the number of second audio features of which first similarity to the first audio feature exceeds the first similarity threshold is 100, the first number is 20, and then the second number may be 80.

In practical implementation, the above is merely one way to further filter the second audio features. Another way is to set a second similarity threshold greater than the first similarity threshold, thereby filtering the second audio features. For example, if the first similarity threshold is 0.5 and the obtained number of second audio features of which first similarity to the first audio feature exceeds the first similarity threshold is 100, the second similarity threshold may be set to 0.6, the first number of second audio features of which similarity to the first audio feature exceeds the second similarity threshold may be 30, and the second number may be 70. In this case, second similarities refer to similarities between the 30 second audio features and the first audio feature that exceed the second similarity threshold, and third similarities refer to similarities between the 70 second audio features and the first audio feature that do not exceed the second similarity threshold.

At operation 1022, the first voiceprint feature and the second voiceprint features are taken as nodes, nodes of which correlations are “correlated” are connected, to obtain the feature correlation graph.

In practical implementation, a feature correlation graph may be obtained as shown in FIG. 4, which is a schematic diagram of a feature correlation graph according to an embodiment of the disclosure.

In FIG. 4, a node B may include a first voiceprint feature, and each of nodes A, C, D, E, F, G, H, and I may include a second voiceprint feature, respectively. If there is a connecting line between nodes in the feature correlation graph, it indicates that a correlation between two connected nodes is correlated, e.g., nodes A and B, and nodes B and C in FIG. 4. It should be noted that after obtaining the feature correlation graph, the correlations between the nodes included in the feature correlation graph may also be determined, which can better reflect the correlations between the nodes. For example, a similarity between the second voiceprint feature included in the node E and the second voiceprint feature included in the node D may be determined, and based on this similarity, a correlation between the second voiceprint feature included in the node E and the second voiceprint feature included in the node D may be determined as “correlated”, then the nodes E and D may be connected in the feature correlation graph.

At operation 103, feature mapping is performed on respective voiceprint features of nodes in the feature correlation graph, to obtain respective third voiceprint features and a confidence level of the nodes.

In some embodiments, the operation that feature mapping is performed on the respective voiceprint features of the nodes in the feature correlation graph to obtain the respective third voiceprint features and the confidence level of the nodes in operation 103 may be achieved through operations 1031 to 1034 shown in FIG. 3C.

At operation 1031, graph convolution processing is performed on the respective voiceprint features of the nodes in the feature correlation graph, to obtain respective graph convolution features of the nodes.

In some embodiments, the operation that graph convolution processing is performed on the respective voiceprint features of the nodes in the feature correlation graph to obtain the respective graph convolution features of the nodes in operation 1031 may be achieved through the following technical solution. A feature correlation matrix corresponding to the feature correlation graph and a node feature matrix corresponding to the respective voiceprint features of the nodes are determined. Graph convolution processing is performed on the feature correlation matrix and the node feature matrix, to obtain the respective graph convolution features of the nodes.

In practical implementation, in order to enable a voiceprint recognition model to perceive information included in the feature correlation graph, a feature correlation matrix and a node feature matrix may be determined based on the feature correlation graph. Taking the nodes A, B, and C in FIG. 4 as an example, a feature correlation matrix composed of the nodes A, B, and C may be obtained as

$$[ \begin{matrix}0 & 1 & 0 \\ 1 & 0 & 1 \\ 0 & 1 & 0\end{matrix} ] ,$$

and a node feature matrix may be [A B C]. Here, a first column in the feature correlation matrix corresponds to the node A, a second column corresponds to the node B, a third column corresponds to the node C, a first row corresponds to the node A, a second row corresponds to the node B, and a third row corresponds to the node C. A value “1” indicates that a correlation between voiceprint features of two nodes is correlated, and a value “0” indicates that a correlation between voiceprint features of two nodes is uncorrelated. A in the node feature matrix is a voiceprint feature included in the node A, B in the node feature matrix is a voiceprint feature included in the node B, and C in the node feature matrix is a voiceprint feature included in the node C.

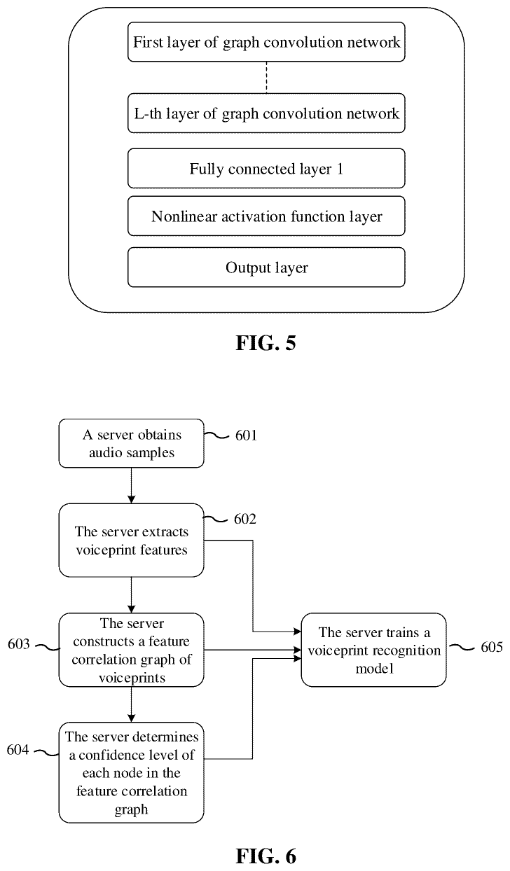

In practical implementation, graph convolution processing is performed on the voiceprint features using a graph convolution network in the voiceprint recognition model, to obtain the respective graph convolution features of the nodes. A structure of the voiceprint recognition model may be as shown in FIG. 5, which is a schematic diagram of a voiceprint recognition model according to an embodiment of the disclosure. The graph convolution network employs a graph convolution formula that may take the feature correlation matrix and the node feature matrix as inputs to obtain the respective graph convolution features of the nodes. The graph convolution formula may be expressed as follows:

$${F}_{l + 1} = σ ( g ( A , {F}_{l} ) {W}_{l} ) \qquad ( 1 )$$

In formula (1), Fₗ₊₁ represents graph convolution features output by an l+1-th layer of the graph convolution network, σ is a nonlinear activation function, Wₗ represents learnable parameters of an l-th layer of the graph convolution network, g(A, Fₗ) is a feature input function, A is a feature correlation matrix, Fₗ represents outputs of the I-th layer of the graph convolution network. When l is 0, Fₗ is a node feature matrix.

According to the above formula (1), it may be seen that the node feature matrix and the feature correlation matrix are input into the graph convolution network. A first layer of the graph convolution network processes the node feature matrix and the feature correlation matrix, and inputs the processed results into a next layer of the graph convolution network for further processing. This process continues layer by layer until a final layer of the graph convolution network outputs the graph convolution features.

At operation 1032, feature mapping is performed on the respective graph convolution features of the nodes, to obtain the respective third voiceprint features of the nodes.

In practical implementation, a fully connected layer shown in FIG. 5 may be added after the graph convolution network, to perform feature mapping on the graph convolution features, thereby obtaining the respective third voiceprint features of the nodes. The fully connected layer includes a weight matrix and a bias vector. For each neuron, it receives the input graph convolution feature, multiplies the graph convolution feature with the weight matrix, and then adds the bias vector to the product, thereby obtaining the corresponding third voiceprint feature.

At operation 1033, nonlinear mapping is performed on the respective third voiceprint features of the nodes, to obtain respective mapping features of the nodes.

In practical implementation, after obtaining the third voiceprint features, a nonlinear activation function, such as an activation function (ReLU, Sigmoid, Tanh, etc.), is applied to introduce nonlinearity and enhance the representation capacity of the model.

At operation 1034, confidence prediction is performed on the respective mapping features of the nodes, to obtain the confidence level of the nodes.

In practical implementation, the mapping features obtained by performing nonlinear mapping through the activation function are input to an output layer, and a predicted node confidence level is output by the voiceprint recognition model. Specifically, the way to predict the confidence level may be referred to in formula (2) as follows:

$$c = {F}_{l} W + b \qquad ( 2 )$$

In formula (2), c is the predicted node confidence level, Fₗ represents the mapping features, W represents learnable parameters, and b is a bias.

At operation 104, a voiceprint recognition result for the first audio is determined based on the respective third voiceprint feature of the nodes, the confidence level of the nodes, or both respective third voiceprint features and the confidence level of the nodes.

In some embodiments, the operation that the voiceprint recognition result for the first audio is determined based on the respective third voiceprint feature of the nodes, the confidence level of the nodes, or both respective third voiceprint features and the confidence level of the nodes in operation 104 may be achieved through the following technical solution. In a case that a number of one or more third audios belonging to a second user among the multiple second audios exceeds a third number, a fourth voiceprint feature of a first node corresponding to the first audio and one or more fifth voiceprint features of one or more second nodes corresponding to the one or more third audios are selected from the respective third voiceprint features of the nodes. A fourth similarity between the fourth voiceprint feature and the one or more fifth voiceprint features is calculated. In a case that the fourth similarity exceeds a third similarity threshold, a voiceprint recognition result that the first audio belongs to the second user is obtained.

In practical implementation, the second user may be a user of the account that generates the first audio. For example, the first audio is generated during a communication between account A and the client, the user of account A stored in the database is the second user, and a number of third audios of the second user exceeds a third number (i.e., the second user has a sufficient number of history calls), then the fourth voiceprint feature corresponding to the first audio and the one or more fifth voiceprint features corresponding to the one or more third audios may be directly obtained from the feature correlation graph. By calculating a similarity(s) between the fourth voiceprint feature and the one or more fifth voiceprint features, it is determined whether the first audio belongs to the second user.

In practical implementation, because the third voiceprint features include information of multiple second audios that are correlated with the first audio, the accuracy of the third voiceprint features extracted through the voiceprint recognition network is higher than that of the voiceprint feature obtained by applying a feature extraction network directly to the first audio. Therefore, in order to ensure the accuracy of the final voiceprint recognition result, the fourth voiceprint feature corresponding to the first audio may be a fourth voiceprint feature obtained by the voiceprint recognition model performing voiceprint feature extraction on the first audio, that is, the fourth voiceprint feature is a voiceprint feature corresponding to the first audio among the third voiceprint features, and the third audios may be audios belonging to the second user among the second audios. Similarly, the fifth voiceprint features of the third audios may be fifth voiceprint features obtained by the voiceprint recognition model performing voiceprint feature extraction on the third audios, that is, the fifth voiceprint features are voiceprint features corresponding to the third audios among the third voiceprint features.

In practical implementation, a way to calculate the fourth similarity between the fourth voiceprint feature and the fifth voiceprint features may be to calculate a cosine similarity between the fourth voiceprint feature and the fifth voiceprint features as the similarity between the fourth voiceprint feature and the fifth voiceprint features, or to calculate a Euclidean distance between the fourth voiceprint feature and the fifth voiceprint features as the similarity between the fourth voiceprint feature and the fifth voiceprint features.

It should be noted that, since the fifth voiceprint features are voiceprint features of the multiple third audios, multiple similarities between the fourth voiceprint feature and the respective fifth voiceprint features may be obtained. After obtaining the multiple similarities, an average of the multiple similarities may be taken as the fourth similarity, or a weighted sum of the multiple similarities may be taken as the fourth similarity. It should be noted that when calculating the weighted sum, weights may be assigned according to a time interval from the current time, that is, the closer to the current time, the greater the weight.

In practical implementation, when it is determined that the fourth similarity exceeds the third similarity threshold, it may be determined that the first audio is generated by the second user. When it is determined that the fourth similarity does not exceed the third similarity threshold, it may be considered that the first audio is produced by someone else borrowing the account of the second user. In this case, the following ways may be used to determine the voiceprint recognition result for the first audio in conjunction with the confidence level.

In some embodiments, the operation that the voiceprint recognition result for the first audio is determined based on the respective third voiceprint feature of the nodes, the confidence level of the nodes, or both respective third voiceprint features and the confidence level of the nodes in operation 104 may be achieved through the following technical solution. In a case that the confidence level is greater than a first confidence threshold and less than a second confidence threshold, one or more fourth nodes that are correlated with a third node corresponding to the first audio are determined in the feature correlation graph. One or more fourth audios corresponding to the one or more fourth nodes are determined among the multiple second audios, and one or more third users to which the one or more fourth audios belong are determined. Based on the one or more third users to which the one or more fourth audios belong, the voiceprint recognition result for the first audio is determined.

In practical implementation, the first confidence threshold is much smaller than the second confidence threshold. When the confidence level is greater than the first confidence threshold and less than the second confidence threshold, it indicates that it is difficult to determine specifically which user the current first audio belongs to. In this case, one or more fourth nodes that are correlated with the third node corresponding to the first audio in the feature correlation graph may be determined. Here, the third node is a node corresponding to the first audio in the feature correlation graph, the one or more fourth nodes are node(s) connected to the third node in the feature correlation graph, and then one or more fourth audios corresponding to the one or more fourth nodes are determined. It should be noted that the one or more fourth audios are actually audio(s) corresponding to the one or more fourth nodes among the second audios, and then a third user to which each fourth node belongs is determined. The voiceprint recognition result for the first audio is determined based on one or more third users.

In some embodiments, the above operation that the voiceprint recognition result for the first audio is determined based on the one or more third users to which the one or more fourth audios belong may be achieved through the following technical solution. If a number of the one or more fourth nodes is one, a voiceprint recognition result that the first audio belongs to the third user is obtained. If the number of the one or more fourth nodes is multiple, for each of the third users, a respective number of the fourth audios associated with the third user is determined; and one of the third users, to which a largest number of the fourth audios belongs, is taken as a fourth user, and a voiceprint recognition result that the first audio belongs to the fourth user is obtained.

In practical implementation, since each audio has a belonging user, when the number of the one or more fourth nodes is one, it indicates that the current node that is correlated with the third node belongs to one user. Therefore, the first audio that belongs to this user may be directly determined as the voiceprint recognition result for the first audio.

In practical implementation, if the number of the one or more fourth nodes is multiple, a fourth user that has a largest number of the fourth nodes belonging to the same user is determined as the user to which the first audio belongs. For example, if there are 10 fourth nodes, with five fourth nodes belonging to user A, three fourth nodes belonging to user B, and two fourth nodes belonging to user C, the fourth user may be determined as user A. In this case, the first audio that belongs to user A may be determined as the voiceprint recognition result for the first audio.

In some embodiments, the operation that the voiceprint recognition result for the first audio is determined based on the respective third voiceprint feature of the nodes, the confidence level of the nodes, or both respective third voiceprint features and the confidence level of the nodes in operation 104 may be achieved through the following technical solution. If the confidence level does not exceed the first confidence threshold or exceeds the second confidence threshold, fifth similarities between a third voiceprint feature of the node corresponding to the first audio and respective third voiceprint features of the nodes corresponding to the second audios are determined. Based on the fifth similarities, a fifth audio with a highest one of the fifth similarities is determined among the multiple second audios. A fourth user to which the fifth audio belongs is determined, and a voiceprint recognition result that the first audio belongs to the fourth user is obtained.

In practical implementation, if it is determined that the confidence level does not exceed the first confidence threshold or exceeds the second confidence threshold, it indicates that the current third voiceprint feature corresponding to the first audio can accurately reflect the information of the first audio. In this case, fifth similarities between the third voiceprint feature of the node corresponding to the first audio and the respective third voiceprint features of the nodes corresponding to the second audios may be determined. Then, a belonging user of a fifth audio with the highest one of the fifth similarities is determined as the belonging user of the first audio. Here, the fifth audio is an audio with the highest fifth similarity to the first audio among the second audios.

As an example, the second audios include audio A, audio B, and audio C. In this case, it is determined that a fifth similarity between a third voiceprint feature of the audio A and the third voiceprint feature of the first audio is 0.5, a fifth similarity between a third voiceprint feature of the audio B and the third voiceprint feature of the first audio is 0.8, and a fifth similarity between a third voiceprint feature of the audio C and the third voiceprint feature of the first audio is 0.7. Therefore, it may be determined that the fifth similarity between the third voiceprint feature of the audio B and the third voiceprint feature of the first audio is the highest, and the audio B may be taken as the fifth audio. If the audio B belongs to user A (i.e., the fourth user), the first audio that belongs to user A may be determined as the voiceprint recognition result for the first audio.

Referring to FIG. 3D, FIG. 3D is a fourth schematic flowchart of a method for voiceprint recognition according to an embodiment of the disclosure. The method includes the following operations.

At operation 101′, in response to a voiceprint recognition request, a first voiceprint feature of a first audio and respective second voiceprint features of a plurality of second audios are determined.

In some embodiments, in order to determine the first voiceprint feature of the first audio and respective second voiceprint features of the plurality of second audios, the voiceprint recognition request may be parsed to obtain the first audio carried by the voiceprint recognition request, and the plurality of second audios of a first user who triggered the voiceprint recognition request within a first time period may be obtained; and voiceprint feature extraction may be performed on the first audio and each of the second audios, to obtain the first voiceprint feature of the first audio and a second voiceprint feature of the respective one of the second audios.

At operation 102′, a plurality of similarities between the first voiceprint feature and the respective second voiceprint features are determined, and a graph is constructed based on the plurality of similarities, the first voiceprint feature and the respective second voiceprint features.

In some embodiments, all similarities exceeding a first threshold may be determined from the plurality of similarities. In response to the determined similarities exceeding the first threshold, the first voiceprint feature and the second voiceprint features corresponding to the determined similarities are connected, so as to construct the graph. Here, the first voiceprint feature and the second voiceprint features are nodes in the graph.

At operation 103′, mapping is performed on the first voiceprint feature and the respective second voiceprint features in the graph, to obtain a plurality of third voiceprint features and a confidence level.

In some embodiments, in order to perform the mapping, graph convolution processing may be performed on the voiceprint features in the graph, to obtain respective graph convolution features of the nodes of the graph; mapping may be performed on the respective graph convolution features of the nodes, to obtain the respective third voiceprint features of the nodes; nonlinear mapping may be performed on the respective third voiceprint features of the nodes, to obtain respective mapping features of the nodes; and confidence prediction may be performed on the respective mapping features of the nodes, to obtain the confidence level of the nodes.

In practical implementation, in order to perform graph convolution processing on the voiceprint features in the graph, a matrix corresponding to the graph and a feature matrix of the nodes may be determined; and graph convolution processing may be performed on the matrix corresponding to the graph and the feature matrix of the nodes, to obtain the respective graph convolution features of the nodes.

At operation 104′, determining a voiceprint recognition result for the first audio based on the plurality of third voiceprint features, the confidence level, or both the plurality of third voiceprint features and the confidence level.

In some embodiments, in response to that a number of one or more third audios of a user among the plurality of second audios exceeds a preset number, determining one or more second voiceprint features corresponding to the one or more third audios may be determined. A similarity between the first voiceprint feature and the one or more second voiceprint features corresponding to the one or more third audios may be calculated. In a case that the similarity exceeds a similarity threshold, a voiceprint recognition result that the first audio belongs to the user may be obtained.

In some embodiments, in response to that the confidence level is greater than a first confidence threshold and less than a second confidence threshold, one or more second voiceprint features of which respective similarities with the first voiceprint feature exceed the first threshold may be determined in the graph. A user corresponding to the one or more second voiceprint features of which the respective similarities with the first voiceprint feature exceed the first threshold may be determined. It may be determined that the first audio is an audio of the user.

In practical implementation, in response to that a number of the one or more second voiceprint features of which similarities with the first voiceprint feature exceeds the first threshold is multiple, a user corresponding to a largest number of the second voiceprint features may be determined, and then it is determined that the first audio is the audio of the user.

In some embodiments, in response to that the confidence level does not exceed the first confidence threshold or exceeds the second confidence threshold, one or more fifth similarities between the third voiceprint feature corresponding to the first voiceprint feature and the respective third voiceprint features corresponding to the one or more second voiceprint features may be determined. An audio corresponding to a highest one of the fifth similarities may be determined based on the fifth similarities. It is determined that the user of the first audio is a user corresponding to a highest one of the fifth similarities.

A method for training a model according to an embodiment of the disclosure is described below. As mentioned above, the electronic device that implements the method for voiceprint recognition in the embodiments of the disclosure may be a terminal, a server, or a combination thereof. Therefore, the executing entity of each operation will not be repeated in the following description.

Referring to FIG. 3E, FIG. 3E is a first schematic flowchart of a method for training a model according to an embodiment of the disclosure, which will be explained in conjunction with the operations shown in FIG. 3E.

At operation 201, through a voiceprint recognition model, a sixth voiceprint feature of a first audio sample and respective seventh voiceprint features of multiple second audio samples are determined.

In practical implementation, the first audio sample and the second audio samples may be historical audios stored in a database, and the second audio samples are audios used for identifying voiceprint information of the first audio sample. Voiceprint information of the second audio samples may be pre-processed and stored in the database, so that the voiceprint information of the second audios may be directly obtained when determining the second audio samples.

In practical implementation, a process of extracting voiceprint features from the first audio sample and the second audio samples may be proceed as follows. First, an audio is framed and segmented into short-term frames. A window function (e.g., Hamming window or Hanning window) may be applied to smooth the beginning and end of the signal, preventing edge effects. Afterwards, the window function is applied to each of the frames, to reduce interference between adjacent frames. A Fast Fourier Transform (FTT) is applied to each of the frames, to transform the audio signal from time domain to frequency domain and obtain a frequency spectrum. The spectrum is passed through a Mel-frequency filter bank to transform the frequency to a Mel-frequency scale, which mimics human auditory perception. The energy in each frequency band is logarithmically processed to enhance discriminability. A discrete cosine transform (DCT) is applied to obtain a cepstrum, which helps to remove redundant information and preserve important frequency information. First few logarithmic Mel-frequency cepstral coefficients are extracted as the voiceprint feature.

At operation 202, a plurality of sixth similarities between the sixth voiceprint feature and the respective seventh voiceprint features are determined, and a feature correlation graph is constructed based on the plurality of sixth similarities.

In practical implementation, a way to determine the sixth similarities between the sixth voiceprint feature and the respective seventh voiceprint features may be to determine a cosine similarity between the sixth voiceprint feature and each of the seventh voiceprint features as a sixth similarity, or to determine a Euclidean distance between the sixth voiceprint feature and each of the seventh voiceprint feature as a sixth similarity.

In practical implementation, after determining the sixth similarities, whether the sixth voiceprint feature and each of the seventh voiceprint features are correlated may be determined based on the respective sixth similarity. When the sixth similarity exceeds a fourth similarity threshold, it indicates that the sixth voiceprint feature and the seventh voiceprint feature are very similar. In this case, it may be determined that the sixth voiceprint feature and the seventh voiceprint feature are correlated. If the sixth similarity does not exceed the fourth similarity threshold, it indicates that the sixth voiceprint feature and the seventh voiceprint feature are dissimilar. In this case, it may be determined that the sixth voiceprint feature and the seventh voiceprint feature are uncorrelated.

In practical implementation, with the sixth voiceprint feature and the seventh voiceprint features are taken as nodes, nodes of which correlations are “correlated” are connected, to obtain the feature correlation graph.

At operation 203, feature mapping is performed on respective voiceprint features of nodes in the feature correlation graph, to obtain a first confidence level of the nodes.

In practical implementation, graph convolution processing is performed on the voiceprint features using a graph convolution network in the voiceprint recognition model, to obtain the respective graph convolution features of the nodes. The graph convolution network includes a graph convolution formula, and the respective voiceprint features of the nodes in the feature correlation graph may be input to the graph convolution formula of the graph convolution network, to obtain the respective graph convolution features of the nodes. The graph convolution formula may be expressed as follows:

$${F}_{l + 1} = σ ( g ( A , {F}_{l} ) {W}_{l} ) \qquad ( 3 )$$

In formula (3), Fₗ₊₁ represents graph convolution features output by an (l+1)-th layer of the graph convolution network, σ is a nonlinear activation function, Wₗ represents learnable parameters of an l-th layer of the graph convolution network, g(A, Fₗ) is a feature input function, A represents the respective voiceprint features of the nodes in the feature correlation graph, Fₗ represents outputs of the l-th layer of the graph convolution network.

In practical implementation, after obtaining the graph convolution features through the graph convolution network, the graph convolution features may be input to a fully connected layer of the voiceprint recognition model, to perform feature mapping on the graph convolution features, thereby obtaining respective eighth voiceprint features of the nodes. The fully connected layer includes a weight matrix and a bias vector. For each neuron, it receives the input graph convolution feature, multiplies the graph convolution feature with the weight matrix, and then adds the bias vector to the product, thereby obtaining the corresponding eighth voiceprint feature.

In practical implementation, after obtaining the eighth voiceprint features, a nonlinear activation function, such as an activation function (ReLU, Sigmoid, Tanh, etc.), is applied to introduce nonlinearity and enhance the representation capacity of the model.

In practical implementation, mapping features obtained by performing nonlinear mapping through the activation function are input to an output layer, and a predicted first confidence level is output by the voiceprint recognition model. Specifically, a way to predict the first confidence level may be referred to in formula (4) as follows:

$$c = {F}_{l} W + b \qquad ( 4 )$$

In formula (4), c is the predicted node confidence level, F represents the mapping features, W represents learnable parameters, and b is a bias.

At operation 204, a loss function is constructed based on the first confidence level of the nodes and second confidence levels annotated for respective audio samples corresponding to the nodes, and one or more parameters of the voiceprint recognition model are updated based on the loss function.

First, a second confidence level corresponding to each of the nodes is generated. A second confidence level of node i is defined as cᵢ, and the confidence level of node i may be:

$${c}_{i} = \frac{1}{\vert {N}_{i} \vert} \sum ( {1}_{{y}_{i} = {y}_{j}} - {1}_{{y}_{i} \neq {y}_{j}} ) * {a}_{i j} \qquad ( 5 )$$

In formula (5), |Nᵢ| is a number of nodes adjacent to node i, yᵢ represents a user to which node i belongs, y represents a user to which node j belongs. 1_{y}_{ᵢ}_{=y}_{ⱼ} indicates that its value is 1 when yᵢ=yⱼ, otherwise its value is 0. 1_{y}_{ᵢ}_{≠y}_{ⱼ} indicates that its value is 1 when yᵢ≠yⱼ, otherwise its value is 0. aᵢⱼ represents a correlation between node i and node j.

A loss function is constructed based on the predicted first confidence level c′ and the determined accurate second confidence level cᵢ of each of the nodes, and one or more parameters of the voiceprint recognition model are updated. The constructed loss function may be:

$$L = \frac{1}{N} {\sum }_{i = 1}^{N} {\vert {c}^{′} - {c}_{i} \vert}^{2} \qquad ( 6 )$$

In formula (6), L is the loss function, c′ is the first confidence level predicted by the voiceprint recognition model, cᵢ is the second confidence level, and N is a number of training samples.

The parameter(s) of the model are updated through the above loss function, which can improve the performance of the trained model.

An exemplary application of the embodiments of the disclosure in an actual application scenario is described below with reference to FIG. 6. FIG. 6 is a schematic flowchart of an application of a method for voiceprint recognition according to an embodiment of the disclosure. The method for voiceprint recognition provided in the embodiments of the disclosure may be implemented through a voiceprint recognition model. The training of the voiceprint recognition model is described below.

At operation 601, a server obtains audio samples.

At operation 602, the server extracts voiceprint features.

Training speech samples are passed through a voiceprint feature extraction network, to obtain first voiceprint features. The voiceprint feature extraction network may be a speaker-identity-based voiceprint feature extraction network (e.g., a residual network, etc.).

At operation 603, the server constructs a feature correlation graph of voiceprints.

A training set includes multiple speakers. Each of the speakers (i.e., the aforementioned user) has multiple audios, totaling N audios. The audios are processed by the voiceprint feature extraction network to obtain the first voiceprint features, and a D-dimensional voiceprint feature may be obtained for each of the audios.

By calculating similarities between the voiceprint feature of each of the nodes and the voiceprint features of other nodes in the feature correlation graph, the feature correlation graph is constructed. A node is denoted by v. A way to construct the specific feature graph is as follows. If a similarity between two nodes is greater than a preset threshold, the two nodes are correlated; otherwise, the two nodes are uncorrelated. A correlation between node i and node j is defined as:

$${a}_{i j} = \{ \begin{matrix}1 , & cos ( {f}_{i} , {f}_{j} ) > thr \\ 0 , & cos ( {f}_{i} , {f}_{j} ) \leq = thr\end{matrix} \qquad ( 7 )$$

In formula (7), aᵢⱼ is the correlation between node i and node j, cos(fᵢ, fⱼ) is a similarity between a voiceprint feature of node i and a voiceprint feature of node j, thr is a similarity threshold, 1 indicates that the correlation between node i and node j is “correlated”, and 0 indicates that the correlation between node i and node j is “uncorrelated”.

The above is to take nodes of which similarity is greater than the similarity threshold as correlated nodes. In practical implementation, a number topk of nodes that are most similar to a node may also be taken as nodes that are correlated with the node, or topk may be used in conjunction with the threshold.

Specifically, a way using the most similar topk is implemented as follows: values of correlations between node i and the topk most similar nodes with node i among other nodes in the feature library are 1, and values of correlations between node i and nodes other than the topk nodes are 0. A way in which topk is used in conjunction with the threshold is implemented as follows: values of correlations between node i and the topk most similar nodes among nodes of which similarity to node i is greater than the preset threshold in the feature library are 1, and values of correlations between node i and nodes other than the topk most similar nodes are 0.

A feature correlation graph may be constructed between N features, and then a feature correlation matrix is constructed based on the feature correlation graph. Taking the nodes A, B, and C in FIG. 4 as an example, a feature correlation matrix composed of the nodes A, B, and C may be obtained as

$$[ \begin{matrix}0 & 1 & 0 \\ 1 & 0 & 1 \\ 0 & 1 & 0\end{matrix} ] .$$

At operation 604, the server determines a confidence level of each node in the feature correlation graph.

In order to learn voiceprint features including correlations through relationships in the feature correlation graph, a node confidence estimation method may be adopted during a learning stage of the graph convolution neural network, to learn the features and the relationship graph. Specifically, a node with high confidence level typically has all of its connected nodes belonging to a voice feature of the same person, while a node with low confidence level typically has its connected nodes belonging to voice features of other persons.

First, a confidence level of each node is generated. A confidence level of node i is defined as cᵢ, and the confidence level of node i may be:

$${c}_{i} = \frac{1}{\vert {N}_{i} \vert} \sum ( {1}_{{y}_{i} = {y}_{j}} - {1}_{{y}_{i} \neq {y}_{j}} ) * {a}_{i j} \qquad ( 8 )$$

In formula (8), |Nᵢ| is a number of nodes adjacent to node i, yᵢ represents a user to which node i belongs, yⱼ represents a user to which node j belongs. 1_{y}_{ᵢ}_{=y}_{ⱼ} indicates that its value is 1 when yᵢ=yⱼ, otherwise its value is 0, 1_{y}_{ᵢ}_{≠y}_{ⱼ} indicates that its value is 1 when yᵢ≠yⱼ, otherwise its value is 0. aᵢⱼ represents a correlation between node i and node j. Taking node B among the three nodes A, B, and C in FIG. 4 as an example, if all the three nodes belong to a same person, a confidence level of node B is 1. If the nodes B and C belong to a same person, and node A belongs to another person, the confidence level of node B is 0.5. If both nodes A and C do not belong to a same person as node B, the confidence level of node B is 0.

The voiceprint recognition model is constructed, which includes an L-layer graph convolution network, a 1-layer fully connected layer, a nonlinear activation function, and an output layer. L is a positive integer greater than or equal to 1. A calculation formula of the graph convolution network may be:

$${F}_{l + 1} = σ ( g ( A , {F}_{l} ) {W}_{l} ) \qquad ( 9 )$$

In formula (9), Fₗ₊₁ represents graph convolution features output by an (l+1)-th layer of the graph convolution network, σ is a nonlinear activation function, Wₗ represents learnable parameters of an l-th layer of the graph convolution network, g(A, Fₗ) is a feature input function, A is a feature correlation matrix, Fₗ represents outputs of the l-th layer of the graph convolution network. When l is 0, Fₗ is a node feature matrix.

The outputs of the graph convolution layer are all input into the fully connected network for feature dimension transformation and learning. Subsequently, after passing through the nonlinear activation function, a fully connected layer is employed to predict a confidence level of the vertices, as shown in the following formula:

$${c}^{′} = {F}_{l} W + b \qquad ( 10 )$$

In formula (10), c′ is the predicted node confidence level, Fₗ represents mapping features, W represents learnable parameters, and b is a bias.

At operation 605, the server trains a voiceprint recognition model.

Afterwards, a loss function is constructed based on the predicted node confidence level c′ and the determined accurate confidence level cᵢ of each of the nodes, and the voiceprint recognition model is trained. The constructed loss function may be:

$$L = \frac{1}{N} {\sum }_{i = 1}^{N} {\vert {c}^{′} - {c}_{i} \vert}^{2} \qquad ( 11 )$$

In formula (11), L is the loss function, c′ is the node confidence level predicted by the voiceprint recognition model, cᵢ is a label value of the confidence level of each of training samples, and N is a number of the training samples.

In practical applications, when one or more identity authentication requests are received, feature extraction is performed on one or more audio recordings to obtain the first voiceprint feature. Then, a feature correlation graph is constructed based on the first voiceprint feature and second voiceprint features in the voiceprint library, and a node feature matrix and the feature correlation graph are input into the trained voiceprint recognition network, to extract third voiceprint features output by the fully connected layer of the voiceprint recognition network. Subsequently, similarity calculations are performed on the third voiceprint features according to the pre-input authentication request, to obtain a fourth similarity. If the fourth similarity is greater than the preset similarity (i.e., the third similarity threshold mentioned above), the third voiceprint features and the first voiceprint feature belong to a same person. If the fourth similarity is less than the preset similarity, the third voiceprint features and the first voiceprint feature do not belong to a same person.

When receiving a voiceprint recognition request for a speech (i.e., the first audio mentioned above), feature extraction is first performed to obtain the first voiceprint feature. Then, the first voiceprint feature is compared with the second voiceprint features of the second audios in the voiceprint library, and a feature correlation graph is constructed. The first voiceprint feature, the second voiceprint features, and the constructed feature correlation graph are input into the voiceprint recognition model. The third voiceprint features output by the fully connected layer of the voiceprint recognition model and the confidence level of the node corresponding to the first audio are extracted.

According to actual experiments, if the high confidence threshold (i.e., the second confidence threshold mentioned above) is 0.52 and the low confidence threshold (i.e., the first confidence threshold mentioned above) is 0.12, and when the confidence level output by the voiceprint recognition model is greater than the preset high confidence level or lower than the preset low confidence level, the accuracy of voiceprint recognition based on the third similarities can meet the accuracy requirements of related services for voiceprint recognition. In practical applications, a two-stage comparison approach may be adopted to improve the efficiency of determining the voiceprint recognition result for the first audio. That is, if the confidence level output by the voiceprint recognition model is greater than the preset high confidence threshold (i.e., the second confidence threshold mentioned above) or lower than the preset low confidence threshold (i.e., the first confidence threshold mentioned above), fifth similarities between the third voiceprint feature of the node and the respective third voiceprint features of the correlated nodes (i.e., the fourth nodes mentioned above) are calculated, and an identity of a third voiceprint feature with the highest fifth similarity is taken as the identity for the first audio. When the confidence level output by the voiceprint recognition model is between the preset high confidence level and the preset low confidence level, a user to which a largest number of fourth nodes belonging to a same user belong is determined as the fourth user, and the first audio belonging to the fourth user is determined as the voiceprint recognition result for the first audio.

It may be understood that, in the embodiments of the disclosure, for related data involving user information and etc., user permission or consent is required when the embodiments of the disclosure are applied to specific products or technologies. Furthermore, the collection, use, and processing of the related data must comply with related laws and regulations, and standards.

An exemplary structure of an apparatus 555A for voiceprint recognition implemented as software modules according to an embodiment of the disclosure is described below. In some embodiments, as shown in FIG. 2A, the software modules stored in the apparatus 555A for voiceprint recognition within a memory 550 may include a determining module 5551, a constructing module 5552, and a mapping module 5553.

The determining module 5551 is configured to determine a first voiceprint feature of a first audio and respective second voiceprint features of multiple second audios in response to a voiceprint recognition request.

The constructing module 5552 is configured to determine a plurality of first similarities between the first voiceprint feature and the respective second voiceprint features, and construct a feature correlation graph based on the plurality of first similarities.

The mapping module 5553 is configured to perform feature mapping on respective voiceprint features of nodes in the feature correlation graph, to obtain respective third voiceprint features and a confidence level of the nodes.

The determining module 5551 is further configured to determine a voiceprint recognition result for the first audio based on the respective third voiceprint feature of the nodes, the confidence level of the nodes, or both respective third voiceprint features and the confidence level of the nodes.

In some embodiments, the constructing module 5552 is further configured to determine, based on the plurality of first similarities, respective correlations of the first voiceprint feature with the second voiceprint features, the correlations comprising “correlated” and “uncorrelated”; and take the first voiceprint feature and the second voiceprint features as nodes, connect nodes of which correlations are “correlated”, to obtain the feature correlation graph.

In some embodiments, the constructing module 5552 is further configured to: for each of the first similarities, if the first similarity exceeds a first similarity threshold, determine that a correlation of the first voiceprint feature with a corresponding one of the second voiceprint features is “correlated”; and if the first similarity does not exceed the first similarity threshold, determine that the correlation of the first voiceprint feature with the corresponding second voiceprint feature is “uncorrelated”.

In some embodiments, the constructing module 5552 is further configured to select, from the plurality of first similarities, a first number of second similarities and a second number of third similarities, herein the second similarities exceed a second similarity threshold, and the third similarities do not exceed the second similarity threshold; and determine that correlations of the first voiceprint feature with respective second voiceprint features corresponding to the first number of second similarities are “correlated”, and determine that correlations of the first voiceprint feature with respective second voiceprint features corresponding to the second number of third similarities are “uncorrelated”.

In some embodiments, the mapping module 5553 is further configured to perform graph convolution processing on the respective voiceprint features of the nodes in the feature correlation graph, to obtain respective graph convolution features of the nodes; perform feature mapping on the respective graph convolution features of the nodes, to obtain the respective third voiceprint features of the nodes; perform nonlinear mapping on the respective third voiceprint features of the nodes, to obtain respective mapping features of the nodes; and perform confidence prediction on the respective mapping features of the nodes, to obtain the confidence level of the nodes.

In some embodiments, the mapping module 5553 is further configured to determine a feature correlation matrix corresponding to the feature correlation graph and a node feature matrix corresponding to the respective voiceprint features of the nodes; and perform graph convolution processing on the feature correlation matrix and the node feature matrix, to obtain the respective graph convolution features of the nodes.

In some embodiments, the determining module 5551 is further configured to: if a number of one or more third audios belonging to a second user among the multiple second audios exceeds a third number, select, from the respective third voiceprint features of the nodes, a fourth voiceprint feature of a first node corresponding to the first audio and one or more fifth voiceprint features of one or more second nodes corresponding to the third audios; calculate a fourth similarity between the fourth voiceprint feature and the one or more fifth voiceprint features; and if the fourth similarity exceeds a third similarity threshold, obtain a voiceprint recognition result that the first audio belongs to the second user.

In some embodiments, the determining module 5551 is further configured to: if the confidence level is greater than a first confidence threshold and less than a second confidence threshold, determine, in the feature correlation graph, one or more fourth nodes that are correlated with a third node corresponding to the first audio; determine one or more fourth audios corresponding to the one or more fourth nodes among the multiple second audios, and determine one or more third users to which the one or more fourth audios belong; and determine, based on the one or more third users to which the one or more fourth audios belong, the voiceprint recognition result for the first audio.

In some embodiments, the determining module 5551 is further configured to: if a number of the one or more fourth nodes is one, obtain a voiceprint recognition result that the first audio belongs to the third user; if the number of the one or more fourth nodes is multiple, for each of the third users, count a respective number of the fourth audios associated with the third user; and take one of the third users, to which a largest number of the fourth audios belongs, as a fourth user, and obtain a voiceprint recognition result that the first audio belongs to the fourth user.

In some embodiments, the determining module 5551 is further configured to: in a case that the confidence level does not exceed the first confidence threshold or exceeds the second confidence threshold, determine fifth similarities between a third voiceprint feature of the node corresponding to the first audio and respective third voiceprint features of the nodes corresponding to each of the second audios; determine, based on the respective fifth similarities, a fifth audio with a highest one of fifth similarities among the multiple second audios; and determine a fourth user to which the fifth audio belongs, and obtain a voiceprint recognition result that the first audio belongs to the fourth user.

In some embodiments, the determining module 5551 is further configured to parse the voiceprint recognition request to obtain the first audio carried by the voiceprint recognition request, and obtain the multiple second audios of a first user who triggered the voiceprint recognition request within a first time period; and perform voiceprint feature extraction on the first audio and each of the second audios, to obtain the first voiceprint feature of the first audio and a second voiceprint feature of the respective one of the second audios.

An exemplary structure of an apparatus 555B for training a model implemented as software modules according to an embodiment of the disclosure is described below. In some embodiments, as shown in FIG. 2B, the software modules stored in the apparatus 555B for training the model within a memory 550 may include a determining module 5554, a constructing module 5555, a mapping module 5556, and an updating module 5557.

The determining module 5554 is configured to determine, through a voiceprint recognition model, a sixth voiceprint feature of a first audio sample and respective seventh voiceprint features of multiple second audio samples.

The constructing module 5555 is configured to determine a plurality of sixth similarities between the sixth voiceprint feature and the respective seventh voiceprint features, and construct a feature correlation graph based on the plurality of sixth similarities.

The mapping module 5556 is configured to perform feature mapping on respective voiceprint features of nodes in the feature correlation graph, to obtain a first confidence level of the nodes.

The updating module 5557 is configured to construct a loss function based on the first confidence level of the nodes and second confidence levels annotated for respective audio samples corresponding to the nodes, and update one or more parameters of the voiceprint recognition model based on the loss function.

An embodiment of the disclosure provides a computer program product, including a computer program or a computer executable instruction stored in a computer-readable storage medium. A processor of an electronic device reads the computer executable instruction from the computer-readable storage medium, and executes the computer executable instruction, causing the electronic device to perform the method for voiceprint recognition in the embodiments of the disclosure or perform the method for training the model according to the embodiments of the disclosure.

An embodiment of the disclosure provides a computer-readable storage medium, having stored thereon a computer executable instruction or a computer program that, when executed by a processor, causes the processor to perform the method for voiceprint recognition according to the embodiments of the disclosure or perform the method for training the model according to the embodiments of the disclosure, such as the method for voiceprint recognition shown in FIG. 3A.

In some embodiments, the computer-readable storage medium may be a random access memory (RAM), a read-only memory (ROM), a flash memory, a magnetic surface storage, an optical disc, a compact disc read-only memory (CD-ROM), or other memories. The computer-readable storage medium may also be various devices that include one or any combination of the aforementioned memories.

In some embodiments, the computer executable instruction may take the form of a program, software, software module, script, or code, written in any form of programming language (including compiled or interpreted languages, or declarative or procedural languages). Furthermore, the computer executable instruction may be deployed in any form, including as a standalone program or as a module, component, subroutine, or other units suitable for use in a computing environment.

As an example, the computer executable instruction may, but is not necessarily, correspond to a file in a file system, and may be stored as part of a file that stores other programs or data, such as in one or more scripts in a Hyper Text Markup Language (HTML) document, in a single file dedicated to the program in question, or in multiple collaborated files (e.g., files that store one or more modules, subprograms, or code parts).

As an example, the computer executable instruction may be deployed to execute on one electronic device, on multiple electronic devices located at one site, or on multiple electronic devices distributed across multiple sites and interconnected by a communication network.

In view of above, the embodiments of the disclosure can achieve the following beneficial effects.

In response to a voiceprint recognition request, a first voiceprint feature of a first audio and respective second voiceprint features of multiple second audios are determined. A plurality of first similarities between the first voiceprint feature and the respective second voiceprint features are determined, and a feature correlation graph is constructed based on the plurality of first similarities. By constructing the feature correlation graph between the first voiceprint feature and the second voiceprint features, second voiceprint features similar to the first voiceprint feature are obtained. Subsequently, only the second voiceprint features included in the feature correlation graph need to be processed, instead of processing all the second voiceprint features, thereby saving computational resources and improving the efficiency of subsequent voiceprint recognition. Feature mapping is performed on respective voiceprint features of nodes in the feature correlation graph, to obtain respective third voiceprint features and a confidence level of the nodes. A voiceprint recognition result for the first audio is determined based on the respective third voiceprint feature of the nodes, the confidence level of the nodes, or both respective third voiceprint features and the confidence level of the nodes. By performing feature mapping on the nodes included in the feature correlation graph, information about the correlated relationship between the nodes in the feature correlation graph is included in the feature mapping process, which improves the accuracy of the obtained third voiceprint features and confidence level, thereby improving the accuracy of subsequent voiceprint recognition result obtained based on the third voiceprint features and/or the confidence level.

The aforementioned descriptions are merely embodiments of the disclosure, and are not intended to limit the scope of protection of the disclosure. Any modifications, equivalent substitutions, improvements, and the like made within the spirit and scope of the disclosure shall fall within the scope of protection of the disclosure.

1. A method for voiceprint recognition, implemented by a computer, the method comprising:
in response to a voiceprint recognition request, determining a first voiceprint feature of a first audio and respective second voiceprint features of a plurality of second audios;
determining a plurality of similarities between the first voiceprint feature and the respective second voiceprint features, and constructing a graph based on the plurality of similarities, the first voiceprint feature and the respective second voiceprint features;
performing mapping on the first voiceprint feature and the respective second voiceprint features in the graph, to obtain a plurality of third voiceprint features and a confidence level; and
determining a voiceprint recognition result for the first audio based on the plurality of third voiceprint features, the confidence level, or both the plurality of third voiceprint features and the confidence level.

2. The method of claim 1, wherein constructing the graph based on the plurality of similarities, the first voiceprint feature and the respective second voiceprint features comprises:
determining, from the plurality of similarities, all similarities exceeding a first threshold; and
in response to the determined similarities exceeding the first threshold, connecting the first voiceprint feature and the second voiceprint features corresponding to the determined similarities, wherein the first voiceprint feature and the second voiceprint features are nodes in the graph.

3. The method of claim 1, wherein performing mapping on the first voiceprint feature and the respective second voiceprint features in the graph, to obtain the plurality of third voiceprint features and the confidence level comprises:
performing graph convolution processing on the voiceprint features in the graph, to obtain respective graph convolution features of nodes of the graph;
performing mapping on the respective graph convolution features of the nodes, to obtain the respective third voiceprint features of the nodes;
performing nonlinear mapping on the respective third voiceprint features of the nodes, to obtain respective mapping features of the nodes; and
performing confidence prediction on the respective mapping features of the nodes, to obtain the confidence level of the nodes.

4. The method of claim 3, wherein performing graph convolution processing on the voiceprint features in the graph, to obtain respective graph convolution features of the nodes of the graph comprises:
determining a matrix corresponding to the graph and a feature matrix of the nodes; and
performing graph convolution processing on the matrix corresponding to the graph and the feature matrix of the nodes, to obtain the respective graph convolution features of the nodes.

5. The method of claim 1, wherein determining a voiceprint recognition result for the first audio based on the plurality of third voiceprint features, the confidence level, or both the plurality of third voiceprint features and the confidence level comprises:
in response to that a number of one or more third audios of a user among the plurality of second audios exceeds a preset number, determining one or more second voiceprint features corresponding to the one or more third audios;
calculating a similarity between the first voiceprint feature and the one or more second voiceprint features corresponding to the one or more third audios; and
in a case that the similarity exceeds a similarity threshold, obtaining a voiceprint recognition result that the first audio belongs to the user.

6. The method of claim 1, wherein determining the voiceprint recognition result for the first audio based on the plurality of third voiceprint features, the confidence level, or both the plurality of third voiceprint features and the confidence level comprises:
in response to that the confidence level is greater than a first confidence threshold and less than a second confidence threshold, determining, in the graph, one or more second voiceprint features of which respective similarities with the first voiceprint feature exceed a first threshold;
determining a user corresponding to the one or more second voiceprint features of which the respective similarities with the first voiceprint feature exceed the first threshold; and
determining that the first audio is an audio of the user.

7. The method of claim 6, wherein determining that the first audio is the audio of the user comprises:
in response to that a number of the one or more second voiceprint features of which similarities with the first voiceprint feature exceeds the first threshold is multiple, determining a user corresponding to a largest number of the second voiceprint features, and determining that the first audio is the audio of the user.

8. The method of claim 6, wherein determining the voiceprint recognition result for the first audio based on the plurality of third voiceprint features, the confidence level, or both the plurality of third voiceprint features and the confidence level comprises:
in response to that the confidence level does not exceed the first confidence threshold or exceeds the second confidence threshold, determining one or more fifth similarities between the third voiceprint feature corresponding to the first voiceprint feature and the respective third voiceprint features corresponding to the one or more second voiceprint features;
determining, based on the fifth similarities, an audio corresponding to a highest one of the fifth similarities; and
determining that the user of the first audio is a user corresponding to a highest one of the fifth similarities.

9. The method of claim 1, wherein determining the first voiceprint feature of the first audio and the respective second voiceprint features of the plurality of second audios comprises:
parsing the voiceprint recognition request to obtain the first audio carried by the voiceprint recognition request, and obtaining the plurality of second audios of a first user who triggered the voiceprint recognition request within a first time period; and
performing voiceprint feature extraction on the first audio and each of the second audios, to obtain the first voiceprint feature of the first audio and a second voiceprint feature of the respective one of the second audios.

10. The method of claim 1, wherein the method is performed through a voiceprint recognition model, and the method further comprises training the voiceprint recognition model, comprising:
determining, through a voiceprint recognition model, a sixth voiceprint feature of a first audio sample and respective seventh voiceprint features of a plurality of second audio samples;
determining a plurality of sixth similarities between the sixth voiceprint feature and the respective seventh voiceprint features, and constructing another graph based on the plurality of sixth similarities, the sixth voiceprint feature and the respective seventh voiceprint features;
performing mapping on the sixth voiceprint feature and the respective seventh voiceprint features in the another graph, to obtain a first confidence level of nodes; and
constructing a loss function based on the first confidence level of the nodes and second confidence levels annotated for respective audio samples corresponding to the nodes, and updating one or more parameters of the voiceprint recognition model based on the loss function.

11. An electronic device, comprising:
a memory, configured to store a computer executable instruction or a computer program; and
one or more processors, when executing the computer executable instruction or the computer program stored in the memory, perform voiceprint recognition,
wherein in performing voiceprint recognition, the one or more processors are configured to:
in response to a voiceprint recognition request, determine a first voiceprint feature of a first audio and respective second voiceprint features of a plurality of second audios;
determine a plurality of similarities between the first voiceprint feature and the respective second voiceprint features, and construct a graph based on the plurality of similarities, the first voiceprint feature and the respective second voiceprint features;
perform mapping on the first voiceprint feature and the respective second voiceprint features in the graph, to obtain a plurality of third voiceprint features and a confidence level; and
determine a voiceprint recognition result for the first audio based on the plurality of third voiceprint features, the confidence level, or both the plurality of third voiceprint features and the confidence level.

12. The electronic device of claim 11, wherein the one or more processors are configured to perform voiceprint recognition through a voiceprint recognition model, and the one or more processors are further configured to train the voiceprint recognition model,
wherein in training the voiceprint recognition model, the one or more processors are configured to:
determine, through the voiceprint recognition model, a sixth voiceprint feature of a first audio sample and respective seventh voiceprint features of a plurality of second audio samples;
determine a plurality of sixth similarities between the sixth voiceprint feature and the respective seventh voiceprint features, and construct another graph based on the plurality of sixth similarities, the sixth voiceprint feature and the respective seventh voiceprint features;
perform mapping on the sixth voiceprint feature and the respective seventh voiceprint features in the another graph, to obtain a first confidence level of nodes; and
construct a loss function based on the first confidence level of the nodes and second confidence levels annotated for respective audio samples corresponding to the nodes, and update one or more parameters of the voiceprint recognition model based on the loss function.

13. The electronic device of claim 11, wherein in constructing the graph based on the plurality of similarities, the first voiceprint feature and the respective second voiceprint features, the one or more processors are configured to:
determine, from the plurality of similarities, all similarities exceeding a first threshold; and
in response to the determined similarities exceeding the first threshold, connect the first voiceprint feature and the second voiceprint features corresponding to the determined similarities, wherein the first voiceprint feature and the second voiceprint features are nodes in the graph.

14. The electronic device of claim 11, wherein in performing mapping on the first voiceprint feature and the respective second voiceprint features in the graph, to obtain the plurality of third voiceprint features and the confidence level, the one or more processors are configured to:
perform graph convolution processing on the voiceprint features in the graph, to obtain respective graph convolution features of nodes of the graph;
perform mapping on the respective graph convolution features of the nodes, to obtain the respective third voiceprint features of the nodes;
perform nonlinear mapping on the respective third voiceprint features of the nodes, to obtain respective mapping features of the nodes; and
perform confidence prediction on the respective mapping features of the nodes, to obtain the confidence level of the nodes.

15. The electronic device of claim 14, wherein in determining the voiceprint recognition result for the first audio based on the plurality of third voiceprint features, the confidence level, or both the plurality of third voiceprint features and the confidence level, the one or more processors are configured to:
in response to that a number of one or more third audios of a user among the plurality of second audios exceeds a preset number, determining one or more second voiceprint features corresponding to the one or more third audios;
calculate a similarity between the first voiceprint feature and the one or more second voiceprint features corresponding to the one or more third audios; and
in a case that the similarity exceeds a similarity threshold, obtain a voiceprint recognition result that the first audio belongs to the user.

16. The electronic device of claim 11, wherein in determining the voiceprint recognition result for the first audio based on the plurality of third voiceprint features, the confidence level, or both the plurality of third voiceprint features and the confidence level, the one or more processors are configured to:
in response to that the confidence level is greater than a first confidence threshold and less than a second confidence threshold, determine, in the graph, one or more second voiceprint features of which respective similarities with the first voiceprint feature exceed a first threshold;
determine a user corresponding to the one or more second voiceprint features of which the respective similarities with the first voiceprint feature exceed the first threshold; and
determine that the first audio is an audio of the user.

17. The electronic device of claim 16, wherein in determining that the first audio is the audio of the user, the one or more processors are configured to:
in response to that a number of the one or more second voiceprint features of which similarities with the first voiceprint feature exceeds the first threshold is multiple, determine a user corresponding to a largest number of the second voiceprint features, and determine that the first audio is the audio of the user.

18. The electronic device of claim 16, wherein in determining the voiceprint recognition result for the first audio based on the plurality of third voiceprint features, the confidence level, or both the plurality of third voiceprint features and the confidence level, the one or more processors are configured to:
in response to that the confidence level does not exceed the first confidence threshold or exceeds the second confidence threshold, determine one or more fifth similarities between the third voiceprint feature corresponding to the first voiceprint feature and the respective third voiceprint features corresponding to the one or more second voiceprint features;
determine, based on the fifth similarities, an audio corresponding to a highest one of the fifth similarities; and
determine that the user of the first audio is a user corresponding to a highest one of the fifth similarities.

19. The electronic device of claim 11, wherein in determining the first voiceprint feature of the first audio and the respective second voiceprint features of the plurality of second audios, the one or more processors are configured to:
parse the voiceprint recognition request to obtain the first audio carried by the voiceprint recognition request, and obtain the plurality of second audios of a first user who triggered the voiceprint recognition request within a first time period; and
perform voiceprint feature extraction on the first audio and each of the second audios, to obtain the first voiceprint feature of the first audio and a second voiceprint feature of the respective one of the second audios.

20. A non-transitory computer-readable storage medium, having stored thereon a computer executable instruction or a computer program that, when executed by a processor, implements a method for voiceprint recognition, comprising:
in response to a voiceprint recognition request, determining a first voiceprint feature of a first audio and respective second voiceprint features of a plurality of second audios;
determining a plurality of similarities between the first voiceprint feature and the respective second voiceprint features, and constructing a graph based on the plurality of similarities, the first voiceprint feature and the respective second voiceprint features;
performing mapping on the first voiceprint feature and the respective second voiceprint features in the graph, to obtain a plurality of third voiceprint features and a confidence level; and
determining a voiceprint recognition result for the first audio based on the plurality of third voiceprint features, the confidence level, or both the plurality of third voiceprint features and the confidence level.
